(19) United States
(12) Patent Application Publication
(10) Pub. No.: US 2010/0273591 A1
(43) Pub. Date: Oct. 28, 2010

(54) MECHANICAL SPRING ELEMENT FOR FLEXIBLE DRIVE

(75) Inventors: Herbert Graf, Bischberg (DE); Patrick Jahnke, Nuernberg (DE); Joerg Kaiser, Lonnerstadt (DE); Stefan Mack, Erlangen (DE); Gerhard Prosch, Hoechstadt (DE); Christoph Rost, Scheinfeld (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/747,015

(22) PCT Filed: Dec. 9, 2008
(86) PCT No.: PCT/EP08/67093

§ 371 Date: Jun. 9, 2010

(30) Foreign Application Priority Data
Dec. 10, 2007 (DE) 10 2007 059 657.1

(51) Int. Cl. F16H 7/12; F16H 7/08

(52) U.S. Cl. 474/138

(57) ABSTRACT

A spring element that is designed for a flexible drive of an internal combustion engine. The spring element has a cylinder, in which a piston is guided in a linearly displaceable manner, a force being applied to the piston by spring means. Corresponding fixing eyes are respectively allocated to the cylinder and the piston for fixing the spring element. A transverse pin is associated with the piston to limit the travel of the spring element. The pin engages in a positive fit with backlash in a longitudinal guiding element of the cylinder.

### FIELD OF THE INVENTION

The present invention relates to a spring element which can also be referred to as a tensioning device and is useable in flexible drives of internal combustion engines. In an installed state, the spring element is operatively connected, indirectly or directly, in particular via a tensioning roller, to a traction means, which is preferably designed as a belt, in order to ensure sufficient pretensioning of the traction means. The spring element is fastened via fastening eyes respectively assigned to the cylinder and to the piston.

Linearly acting tensioning elements are used to ensure constant pretensioning of traction means, in particular endless belts in flexible drives, such as unit drives and/or control drives of internal combustion engines.

The design of the linearly acting tensioning element according to DE 10 2004 054 636 A1 comprises a base element which is positioned in a fixed location, is arranged pivotably and is connected to an axially movable displacement part. In this case, the displacement part is connected indirectly or directly, in particular via a tensioning roller, to the traction means. Furthermore, the tensioning element includes a rotary shaft part which is arranged coaxially with respect to the displacement part, is rotationally loaded by means of a compression spring and is supported on a base element and, via a movement thread, on the displacement part. The spring element here at the same time takes on a mechanical damping function of the flexible drive.

### OBJECT OF THE INVENTION

The present invention is based on the object of implementing a robust and weight-optimized tensioning device which can be produced cost-effectively and is designed as a spring element, with an effective travel limitation being included.

This object is achieved in that, to limit the travel of the spring element, a transverse pin which is assigned to the piston engages at least on one side in a form-fitting manner in a longitudinal guide of the cylinder. This design ensures effective transport protection of all of the components associated with the spring element. In the installed state of the tensioning device, the transverse pin also brings about protection against disintegration in the event of the traction means tearing. The spring element according to the invention comprises components which are produced from light metal or plastic and are linearly displaceable with respect to one another, in particular the piston and cylinder, in order to implement a tensioning device which is optimized in terms of weight and construction space. A rolling body needle which is placed into the piston and belongs to a commercially available needle roller bearing is preferably suitable as a suitable transverse pin to limit the travel.

The transverse pin which is placed in the piston and forms a travel limitation also brings about a positional orientation between the components piston and cylinder which are displaceable relative to each other. The transverse pin, which is placed in a positionally fixed manner into a bore in the piston by means of a press fit or a cohesive bond engages at least in one side in a form-fitting manner and with backlash in diametrically opposite longitudinal guides of the cylinder. The fully preassembled spring element according to the invention can therefore be supplied, for example to an assembly process, in order to complete a tensioning system for a flexible drive. The transverse pin in conjunction with the longitudinal guide also forms “protection against snapping” which prevents the piston and the cylinder from sliding apart in an uncontrolled manner, for example if the traction means, in particular a belt or a toothed belt, tears.

A further design feature relates to a compression spring which encloses part of the outside of the piston or the cylinder and is designed in such a manner that the external contour thereof does not exceed the contour of the remaining part of the component which is not enclosed by the spring element. The two piston and cylinder components which are displaceable linearly with respect to each other and can also be referred to as housings each have a fastening eye on the end side for receiving a separate screw connection via which the spring element is coupled, for example, on one side to a housing of the internal combustion engine and on the other side to a pivot lever, the end side of which comprises a tensioning roller supported on the traction means. A helical compression spring which, for example, is supported on the piston side on a collar and on the cylinder side on a step is preferably suitable as the spring means. The spring means inserted between the piston and cylinder does not exceed either the external contour of the piston or that of the cylinder, emphasizing the compact construction of the spring element according to the invention. Advantageously in this case, in addition, the piston can be guided in the cylinder in a manner protected against soiling and the ingress of moisture or liquid, for example in conjunction with an elastic bellows.

As a measure for reducing friction and wear, the piston is guided on the inner wall of the cylinder via a sleeve. The sleeve, which is of closed or slotted design and forms a sliding bearing bush, can be fastened to the piston in a form-fitting and/or frictional manner.

For a spring element in which the spring means extends virtually over the entire length of the cylinder or of the piston, it is appropriate to place a sheath-type sleeve in an annular gap which is delimited radially by the spring means and the outer wall of the cylinder. On the inside, the sleeve forms a delimitation for the transverse pin which is placed in the piston and projects into the longitudinal guide of the cylinder.

Polyamide, in particular PA 66 H, is suitable as a preferred material for the sleeve of the piston and the sheath-type sleeve assigned to the cylinder. Furthermore, according to the invention, a plastic, in particular PA 66 having a glass fiber content ≧35%, is also provided for the cylinder and the piston.

For the spring element according to the invention, it is also appropriate that said device can be compressed and/or held together in a compressed transport position by means of a separate holding clip.

As a measure for further reducing weight, the piston and the cylinder can be designed, according to the invention, at least in the region of the displaceable zone, as hollow bodies or as tubular bodies. Furthermore, it is appropriate to produce the spring element from different materials. For example, the piston can be produced as a sheet-metal body which interacts with a plastic cylinder. In addition, that region of the plastic cylinder which is linearly displaceable in a plastic housing can be enclosed in areas on the outer side by a sheet-metal sheath.

Furthermore, it is provided to position the spring element in an end position or secure said spring element in said position. Preferably suitable for this purpose is a separate spring connector which positions the transverse pin of the piston with respect to the housing designed as a cylinder in an end position in which a component of the spring element is secured in a compressed manner supported on a stop. The spring element can therefore be supplied or transported in a pretensioned position in a manner optimized in terms of construction space, which also simplifies installation.

### DESCRIPTION OF THE FIGURES

Exemplary embodiments of the invention are described below, the invention not being restricted to said exemplary embodiments. In the figures:

FIG. 1 shows a spring element according to the invention in a longitudinal section in which a piston which is designed as a guide sleeve is guided displaceably in a cylinder;

FIG. 2 shows a spring element which is designed in an alternative manner to FIG. 1, with a piston which forms a plastic element and is enclosed in areas by a sleeve;

FIG. 3 shows the spring element in a sectional illustration offset by 90° with respect to FIG. 2;

FIG. 4 shows the spring element according to FIG. 2 and fixed in an end position by means of a transverse pin;

FIG. 5 shows the spring element according to FIG. 5 in a sectional illustration offset by 90°; and

FIG. 6 shows a perspective view of the spring element which is illustrated in a compressed position according to FIG. 4.

### DETAILED DESCRIPTION OF THE DRAWINGS

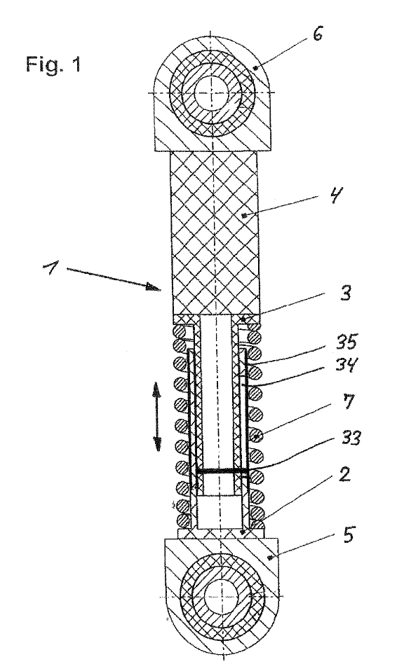

FIG. 1 shows a design of a spring element 1 comprising a cylinder 2 which forms a guide sleeve and in which a tubular piston 3 is displaceably guided. The piston 3 is preferably extended on the side facing away from the cylinder 2 by a spacer 4 produced from plastic. The cylinder 2 and the spacer 4 are each assigned a fastening eye 5, 6 with which the spring element 1 is connected, for example in a fixed location, but at the same time pivotably, to a housing of an internal combustion engine or is assigned to a pivot lever which is not depicted in FIG. 1 and is indirectly connected to a tensioning roller which acts upon the traction means. A spring means 7 inserted between the cylinder 2 and the piston 3 exerts an expanding force which, transmitted to the tensioning roller, always ensures that the traction means is sufficiently pretensioned. The structural configuration of the spring means 7 is matched to a sheath-type structure of the spacer 4. Correspondingly, the outside diameter of the spring element is identical to or smaller than that of the spacer 4. To produce a travel limitation, a transverse pin 33 is inserted in the piston 3, said transverse pin emerging out of the external contour of the piston 3, engaging with backlash in a longitudinal guide 34 of the cylinder 2 and therefore at the same time bringing about a positional orientation of said components. To avoid contact with the spring means 7, the cylinder 2 is enclosed by a sheath-type sleeve 35 which forms a radial delimitation for the transverse pin 33.

As an alternative to the spring element 7 which surrounds the cylinder 2 on the outside, it is appropriate to arrange the spring means 7 within the piston 3 which is designed as a sleeve. For this purpose, the piston 3 preferably has an enlarged inside diameter and a cylinder 2 matched thereto.

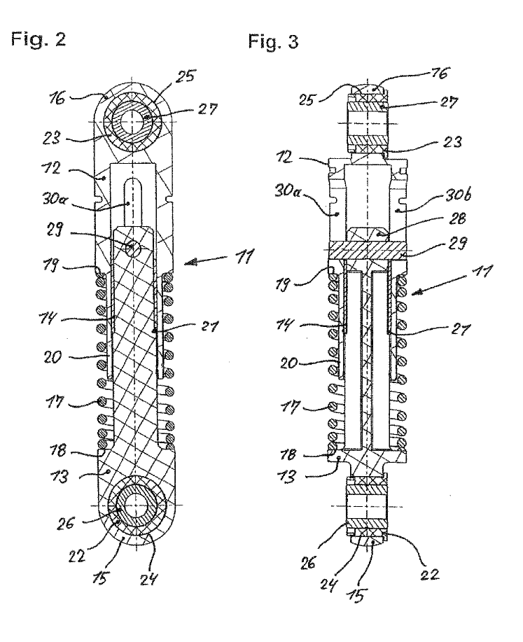

The spring element 11 according to FIG. 2 comprises a cylinder 12 which is assigned a piston 13, said cylinder and piston correspondingly being produced from plastic, wherein the piston 13 has a length-delimited, metallic sleeve 14 via which the piston 13 is guided on an inner wall of the cylinder 12. The cylinder 12 and the piston 13 are respectively connected integrally to a fastening eye 15, 16, which correspondingly comprise a bearing ring 22, 23 which is inserted in an annular gap formed between a receptacle 24, 25 and a central bush 26, 27. The spring means 17 which is supported on one side on a collar 18 of the fastening eye 15 and on the other side on a step 19 of the cylinder 12 serves to exert an expanding force. Starting from the step 19, the cylinder 12 forms a diameter-reduced section 20 which is enclosed on the outer side by the spring means 17 and furthermore on the end side encloses a seal 21 which seals a sealing gap arising between the piston 13 and the cylinder 12.

FIG. 3 shows the spring element 11 in a longitudinal section offset by 90° with respect to FIG. 2. According to said figure, the piston 13 has a flat profile, starting from the collar 18 of the fastening eye 15, the end side of the flat profile forming a cylindrical section 28. The section 28 is enclosed on the outer side by the sleeve 14 and furthermore serves to accommodate a transverse pin 29 fixed in the section 28. The transverse pin 29 which is extended axially on both sides engages in a form-fitting manner with backlash in longitudinal guides 30a, 30b of the cylinder 12 and there forms a travel limitation and at the same time a captive securing means, as a result of which all of the components of the spring element 11 are captively held together.

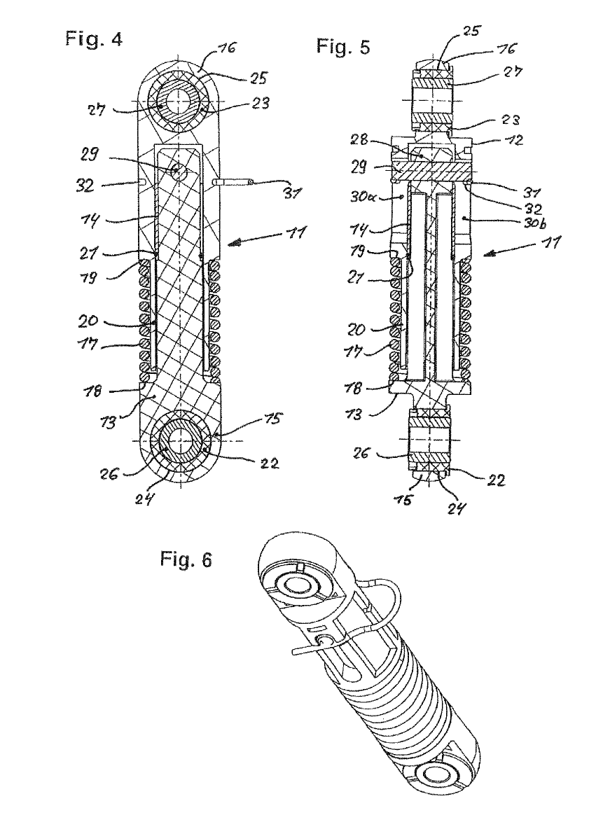

FIGS. 4, 5 and 6 show the spring element 11 in a pretensioned position. For this purpose, there is a spring connector 31 of clasp-like design with which the piston 13 is positioned in an end position in relation to the cylinder 12. The cylinder 12 encloses an annular groove 31 for the form-fitting accommodation of the spring connector 31. In the pretensioned position of the spring element 2 and the inserted spring connector 31, the transverse pin 29 is supported in areas in the region of the longitudinal guide 30a, 30b on the spring connector 31.

### List of Reference Numbers

1 Spring element
2 Cylinder
3 Piston
4 Spacer
5 Fastening eye
6 Fastening eye
7 Spring means
11 Spring element
12 Cylinder
13 Piston
14 Sleeve
15 Fastening eye
16 Fastening eye
17 Spring means
18 Collar
19 Steps
20 Section
21 Seal
22 Bearing ring
23 Bearing ring
24 Receptacle
25 Receptacle
26 Bush
27 Bush
28 Section
29 Transverse pin
30a Longitudinal guide
30b Longitudinal guide
31 Spring connector
32 Annular groove
33 Transverse pin
34 Longitudinal guide
35 Sheath-type sleeve

1. A spring element, used in a flexible drive of an internal combustion engine, comprising:
a cylinder in which a piston is guided in a linearly displaceable manner and has a force applied thereto by a spring means,
wherein, to fasten the spring element, the cylinder and the piston correspondingly each have a fastening eye, and
wherein, to limit travel of the spring means, a transverse pin which is assigned to the piston engages in a form-fitting manner in a longitudinal guide of the cylinder.

2. The spring element of claim 1, wherein a rolling body needle of a commercially available needle roller bearing is fitted in the piston as the transverse pin to limit the travel.

3. The spring element of claim 1, wherein a helical compression spring which is supported on a piston side on a collar and on a cylinder side on a step is provided as the spring means.

4. The spring element of claim 1, wherein the spring means which is inserted between the piston and the cylinder does not exceed an external contour of the piston and the cylinder.

5. The spring element of claim 1, wherein the piston is guided in the cylinder via a sleeve.

6. The spring element of claim 5, wherein the sleeve, which is of closed or slotted design and forms a sliding bearing bush, is fastened to the piston in a form-fitting and/or frictional manner.

7. The spring element of claim 1, wherein the cylinder comprises a sheath-type sleeve which is enclosed on an outer side by the spring means.

8. The spring element of claim 5, wherein the sleeve is produced from polyimide, such as PA 66 H.

9. The spring element of claim 1, wherein the cylinder and the piston are produced from plastic.

10. The spring element of claim 8, wherein PA 66 having a glass fiber content ≧35% is provided as a material for the piston and the cylinder.

11. The spring element of claim 1, wherein the spring element can be compressed and/or held in a compressed position by means of a separate device or a separate holding clip.
